(19) United States
(12) Patent Application Publication
(10) Pub. No.: US 2020/0193460 A1
(43) Pub. Date: Jun. 18, 2020

(54) VEHICLE INFORMATION MANAGEMENT DEVICE AND VEHICLE INFORMATION MANAGEMENT METHOD

(71) Applicant: TOYOTA JIDOSHA KABUSHIKI KAISHA, Aichi-ken (JP)

(72) Inventors: Ryohei OBARA, Nagakute-shi (JP); Masaki ITO, Toyota-shi (JP); Makoto KAKUCHI, Toyota-shi (JP); Mutsumi MATSUURA, Okazaki-shI (JP); Hiroaki SUGIYAMA, Nagoya-shi (JP); Yuichi TASHIRO, Owariasahi-shi (JP)

(21) Appl. No.: 16/681,002

(22) Filed: Nov. 12, 2019

(30) Foreign Application Priority Data
Dec. 17, 2018 (JP) 2018-235552

(51) Int. Cl. G06Q 30/02; G07C 5/00; B60L 53/66; B60L 58/12; G01C 21/34

(52) U.S. Cl. CPC G06Q 30/0207; G07C 5/004; B60L 53/665; B60L 2240/622; G01C 21/3461; G01C 21/3469; B60L 58/12

(57) ABSTRACT

A vehicle information management device includes: an acquisition section that acquires location information from a traveling vehicle; a determination section that determines whether the vehicle has traveled in a specified underpopulated area on the basis of the location information; and an offering section that offers a travel reward to a user of the vehicle in the case where it is determined that the vehicle has traveled in the specified underpopulated area.

### INCORPORATION BY REFERENCE

The disclosure of Japanese Patent Application No. 2018-235552 filed on Dec. 17, 2018 including the specification, drawings and abstract is incorporated herein by reference in its entirety.

### BACKGROUND

### 1. Technical Field

The disclosure relates to a vehicle information management device and a vehicle information management method.

### 2. Description of Related Art

Conventionally, as a travel management system for vehicles, a travel management system including a vehicle information communication device, a management server, and a personal digital assistant has been known. The vehicle information communication device sends travel information of a vehicle, the management server manages a travel state of the vehicle, and the personal digital assistant is configured to be accessible to the travel information of the automatically traveling vehicle that is stored in the management server (see Japanese Patent Application Publication No. 2018-112930 (JP 2018-112930 A)).

### SUMMARY

However, the travel management system disclosed in JP 2018-112930 A does not promote travel of the vehicle in/to an underpopulated area as a destination or a route of the vehicle. Thus, vehicle users are not guided to the underpopulated area, which prevents revitalization of the underpopulated area.

In view of the above problem, the disclosure has a purpose of providing a vehicle information management device and a vehicle information management method capable of revitalizing an underpopulated area.

A vehicle information management device according to an aspect of the disclosure includes: an acquisition section that acquires location information from a traveling vehicle; a determination section that determines whether the vehicle has traveled in a specified underpopulated area based on the location information; and an offering section that offers a travel reward to a user of the vehicle in a case where it is determined that the vehicle has traveled in the specified underpopulated area.

A vehicle information management method according to another aspect of the disclosure includes: a step of acquiring location information from a traveling vehicle; a step of determining whether the vehicle has traveled in a specified underpopulated area based on the location information; and a step of offering a travel reward to a user of the vehicle in a case where it is determined that the vehicle has traveled in the specified underpopulated area.

According to the disclosure, the underpopulated area can be revitalized.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a configuration diagram of a schematic configuration of a vehicle information management system according to an embodiment;

FIG. 2 is a table illustrating a data structure of a user table in FIG. 1;

FIG. 3 is a table illustrating a data structure of an underpopulated area table in FIG. 1;

FIG. 4 is a table illustrating a data structure of a charging facility table in FIG. 1;

FIG. 5 is a table illustrating a data structure of a vehicle data file in FIG. 1;

FIG. 6 is a table illustrating a data structure of an electricity supply data file in FIG. 1;

FIG. 7 is a flowchart illustrating schematic operation of the vehicle information management device according to the embodiment that offers a travel reward;

FIG. 8 is a flowchart illustrating schematic operation of the vehicle information management device according to the embodiment that provides advertisement information;

FIG. 9 is a flowchart illustrating schematic operation of the vehicle information management device according to the embodiment that provides charging facility information; and

FIG. 10 is a flowchart illustrating schematic operation of the vehicle information management device according to the embodiment that offers a supply reward.

### DETAILED DESCRIPTION OF EMBODIMENTS

A description will hereinafter be made on an embodiment of the disclosure. In the following description of the drawings, the same or similar portions will be denoted by the same or similar reference numerals and symbols. It should be noted that the drawings are schematically illustrated. In addition, it should be understood that the technical scope of the disclosure is not limited to such an embodiment.

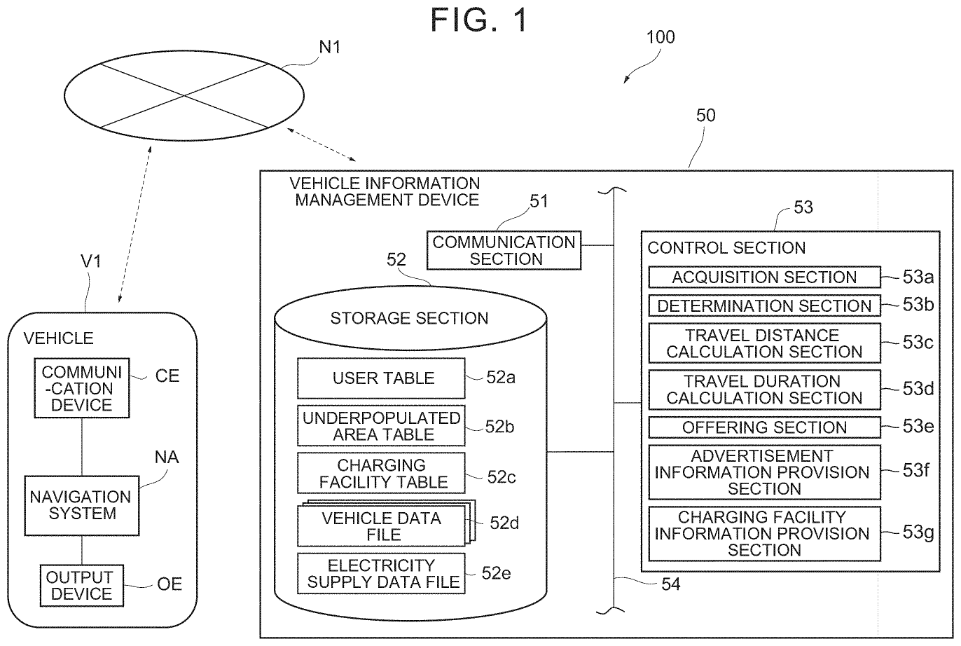

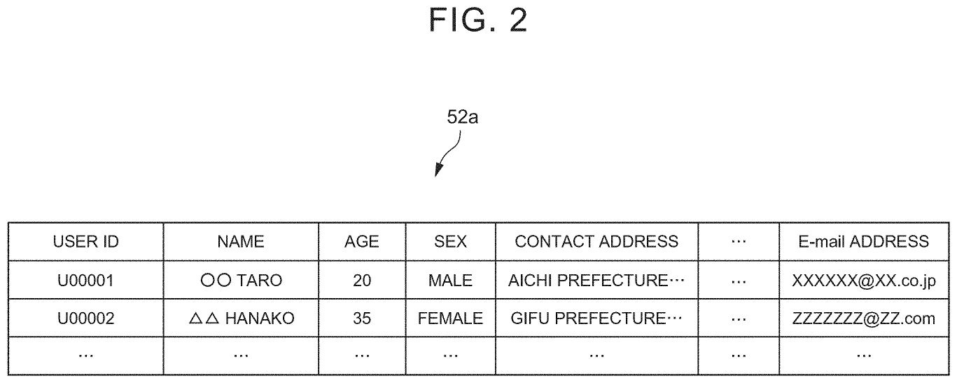

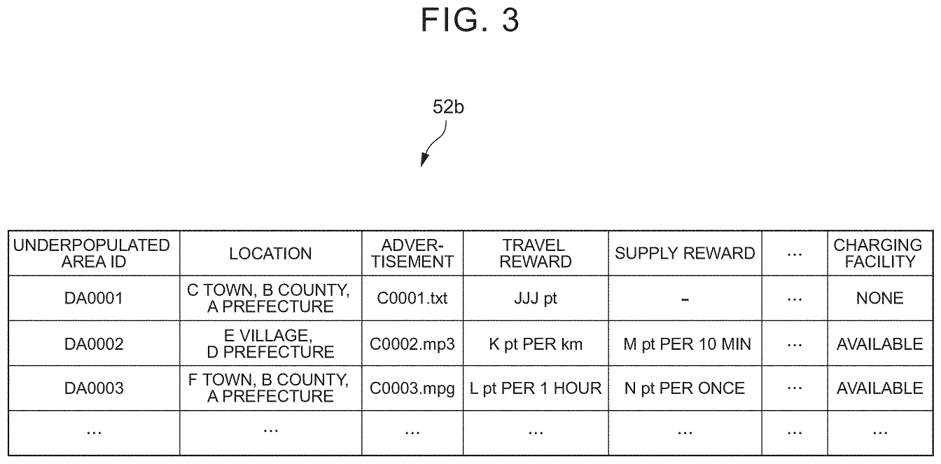

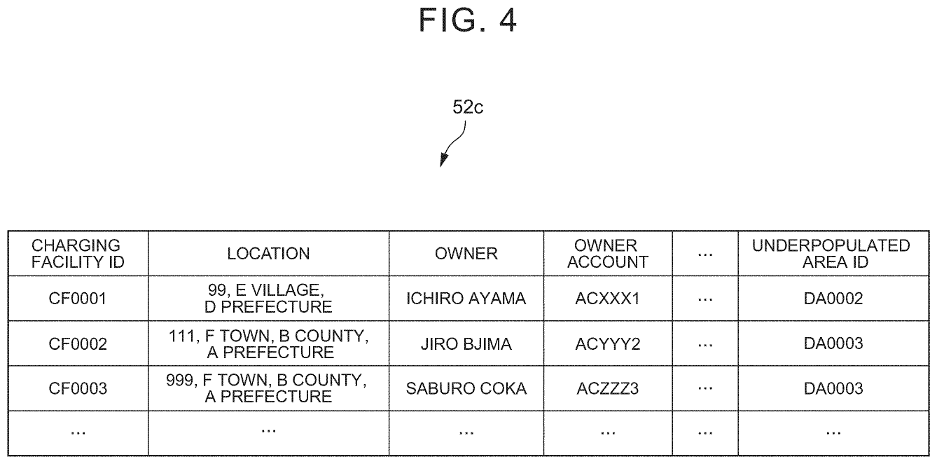

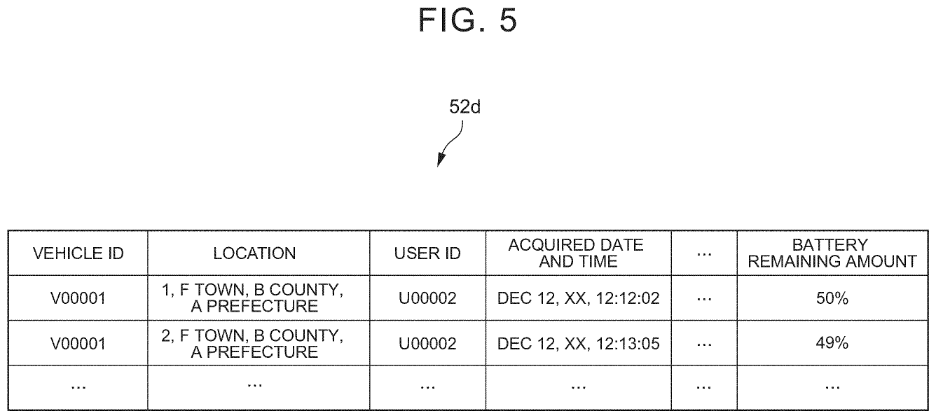

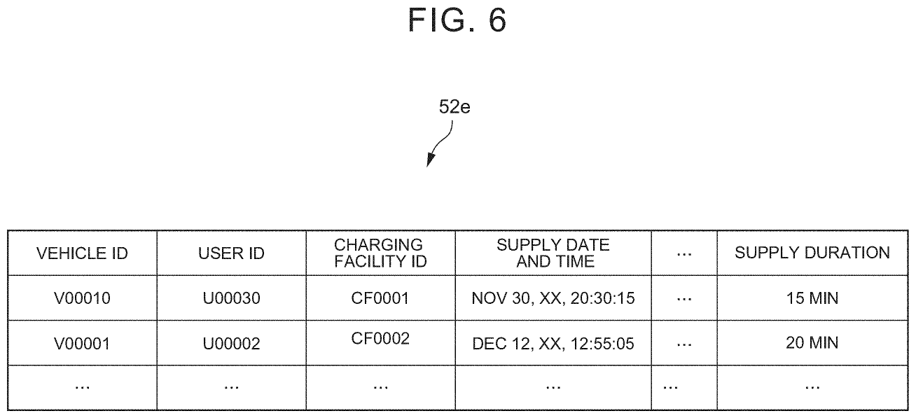

FIG. 1 to FIG. 10 are provided to illustrate a vehicle information management device and a vehicle information management method according to the embodiment. A description will initially be made on a schematic configuration of a vehicle information management system according to the embodiment with reference to FIG. 1 to FIG. 6. FIG. 1 is a configuration diagram of a schematic configuration of a vehicle information management system 100 according to the embodiment. FIG. 2 is a table illustrating a data structure of a user table 52a in FIG. 1. FIG. 3 is a table illustrating a data structure of an underpopulated area table 52b in FIG. 1. FIG. 4 is a table illustrating a data structure of a charging facility table 52c in FIG. 1. FIG. 5 is a table illustrating a data structure of a vehicle data file 52d in FIG. 1. FIG. 6 is a table illustrating a data structure of an electricity supply data file 52e in FIG. 1.

As illustrated in FIG. 1, the vehicle information management system 100 includes a vehicle information management device 50. In addition, the vehicle information management system 100 is configured to include a network N1 and a vehicle V1.

The vehicle V1 and the vehicle information management device 50 are connected in a mutually communicable manner via the network N1. The network N1 is a mobile communication network, for example. Alternatively, the network N1 may be a combination of the mobile communication network and another network, such as the Internet, a local area network (LAN), a dedicated line, a telephone line, an intracompany network, Bluetooth®, Wireless Fidelity (Wi-Fi), or another communication line. In this case, connection between the mobile communication network and the other network may be wired or wireless.

In this embodiment, FIG. 1 illustrates an example in which the one network N1 is provided in the vehicle information management system 100. However, the disclosure is not limited thereto. The number of the networks provided in the vehicle information management system 100 may be two or more.

For example, a communication device CE, a navigation system NA, and an output device OE are mounted on the vehicle V1.

In this embodiment, FIG. 1 illustrates an example in which the one vehicle V1 is provided in the vehicle information management system 100. However, the disclosure is not limited thereto. The plural number of the vehicles may be provided in the vehicle information management system 100.

Here, in the case where the plural vehicles are provided in the vehicle information management system 100, in order to identify the vehicles, a unique vehicle

ID is assigned to each of all the vehicles provided in the vehicle information management system 100. Similarly, in regard to vehicle owners, drivers, and renters in the case where the vehicles are rental cars or sharing cars, and the like (hereinafter collectively referred to as “users”), a unique user ID is assigned to each of all the users in the vehicle information management system 100.

The navigation system NA is a configured to guide through a route from a current location to a destination. The navigation system NA includes a Global Positioning System (GPS) receiver and can acquire location information by a positioning technology of the GPS. Alternatively, the navigation system NA may acquire the location information by the positioning using a base station (not illustrated) of the network N1 instead of the positioning technology of the GPS or with the positioning technology of the GPS.

The navigation system NA is connected to the communication device CE and the output device OE. The navigation system NA outputs the location information such as the current location to the communication device CE at specified intervals.

The communication device CE is configured to be communicable with the vehicle information management device 50 via the network N1. The communication device CE stores the vehicle ID of the vehicle V1 in own memory, for example The communication device CE receives the location information such as the current location from the navigation system NA, and also receives information on the user ID of the user of the vehicle V1 and the like from equipment (not illustrated) mounted on the vehicle V1. In the case where the vehicle V1 is an electrically-driven vehicle, the communication device CE also receives information on a battery remaining amount. The communication device CE sends vehicle data, which is generated by adding the vehicle ID to these types of the information and is information on the traveling vehicle V1, to the vehicle information management device 50 via the network N1.

In addition, the communication device CE sends electricity supply data to the vehicle information management device 50 via the network N1. The electricity supply data is generated in the vehicle V1, for example, when the vehicle V1 is electrically connected to a charging facility located in a specified underpopulated area, starts being supplied with electricity, finishes being supplied with the electricity, and is then electrically disconnected from the charging facility.

Furthermore, the communication device CE receives advertisement information and charging facility information, which will be described later, from the vehicle information management device 50 via the network N1.

The output device OE is configured to be able to output the information. For example, the output device OE can be configured to include a display device, such as a liquid crystal display, an electroluminescence (EL) display, or a plasma display, and a speaker.

The output device OE receives the advertisement information via the navigation system NA. Of the advertisement information, the output device OE displays text information including letters, numbers, symbols, or the like, image information, or video information on the display device, and outputs audio information from the speaker.

Note that the term “electrically-driven vehicle” in the present application means a vehicle that uses electric power as at least a part of power. Thus, for example, of a so-called hybrid vehicle having two or more power sources, the electrically-driven vehicle includes a hybrid vehicle, at least one power source of which is the electric power.

The vehicle information management device 50 includes a communication section 51, a storage section 52, and a control section 53, for example. The vehicle information management device 50 further includes a bus 54 that is configured to exchange a signal and/or data between the sections of the vehicle information management device 50.

The communication section 51 is used to communicate (exchange) the data. The communication section 51 is configured to be communicable with the vehicle V1, which is connected to the network N1, via the network N1 on the basis of one or plural specified communication methods. In the case where the other network that is combined with the network N1 is the Internet, at least one of the communication methods of the communication section 51 is a communication method according to the Internet protocol.

The storage section 52 is configured to store programs, the data, and the like. The storage section 52 is configured to include a hard disk drive, a solid state drive, or the like, for example. The storage section 52 stores in advance the various programs executed by the control section 53, the data required for the execution of the programs, and the like.

The storage section 52 stores the user table 52a in advance. The user table 52a is created by gathering information on the users of the vehicle V1.

As illustrated in FIG. 2, in the user table 52a, the information on the user is stored as one record for each user ID. The information on the user includes information such as a name, age, sex, a contact address, and an e-mail address.

Referring back to the description on FIG. 1, the storage section 52 stores the underpopulated area table 52b in advance. The underpopulated area table 52b is created by gathering information on the specified underpopulated areas.

As illustrated in FIG. 3, in the underpopulated area table 52b, the information on the underpopulated area is stored as one record for each underpopulated area ID. Here, in the case where the plural specified underpopulated areas exist, in order to identify the underpopulated areas, the unique underpopulated area ID is assigned to each of the underpopulated areas in the vehicle information management system 100.

The information on the underpopulated area includes information such as a location, advertisement, a travel reward, a supply reward, and the charging facility. The advertisement information relates to the travel reward that is offered to the user of the vehicle V1 when the vehicle V1 travels in the underpopulated area. The advertisement information is text information including letters, numbers, symbols, or the like, image information, video information, audio information, or information of a combination of these, for example.

Travel reward information determines a basis of the travel reward in the underpopulated area. The travel reward information is points that can be used in the underpopulated area, for example. As illustrated in FIG. 3, in the travel reward information, the basis may differ by underpopulated area.

Supply reward information determines a basis of the supply reward that is offered to an owner of the charging facility on the basis of electricity supply information, which will be described later. Similar to the travel reward information, the supply reward information is points that can be used in the underpopulated area, for example. As illustrated in FIG. 3, in the supply reward information, the basis may differ by underpopulated area.

Referring back to the description on FIG. 1, the storage section 52 stores the charging facility table 52c in advance. The charging facility table 52c is created by gathering information on the charging facilities.

As illustrated in FIG. 4, in the charging facility table 52c, the information on the charging facility located in the underpopulated area, the information on which is stored in the underpopulated area table 52b, is stored as one record for each charging facility ID. Here, in order to identify the plural charging facilities, the unique charging facility ID is assigned to each of the charging facilities in the vehicle information management system 100.

The information on the charging facility includes information on a location, the owner, an owner account, and the like, for example. In addition, the information on the charging facility may include information on the number of the charging facilities, types of the charging facilities, and the like, for example. Furthermore, the charging facility ID is associated with the underpopulated area ID. In this way, it is possible to identify the underpopulated area where the charging facility is located from the charging facility ID, and thus to access the information on the underpopulated area in the underpopulated area table 52b.

Referring back to the description on FIG. 1, the storage section 52 also stores the vehicle data file 52d. The vehicle data file 52d is a file that is created per vehicle, for example, and stores the vehicle data described above.

As shown in FIG. 5, in the vehicle data file 52d, each of the vehicle data that is sent from the vehicle V1 at specified intervals is stored as one record. When acquired by an acquisition section 53a, which will be described later, the vehicle data is added with information on an acquired date and time. In regard to storing of the vehicle data in the vehicle data file 52d, for example, the latest (last) vehicle data is added thereto as the last record in the vehicle data file 52d. Furthermore, the vehicle ID is associated with the user ID. In this way, the vehicle user can be identified from the vehicle ID. Thus, the information on the user in the user table 52a can be accessed.

Referring back to the description on FIG. 1, the storage section 52 also stores the electricity supply data file 52e. The electricity supply data file 52e stores the electricity supply data that is used to offer the supply reward.

As shown in FIG. 6, in the electricity supply data file 52e, the electricity supply data that is sent from the vehicle V1 is stored as one record. The electricity supply data includes the information on the vehicle ID, the user ID, the charging facility ID, a supply date and time, supply duration, and the like, for example. In regard to storing of the electricity supply data in the electricity supply data file 52e, for example, the latest (last) electricity supply data is added thereto as the last record in the electricity supply data file 52e.

Note that a structure and a format of each of the user table 52a, the underpopulated area table 52b, the charging facility table 52c, the vehicle data file 52d, and the electricity supply data file 52e are not limited to the example illustrated in each of FIG. 2 to FIG. 6. For example, each of the user table 52a, the underpopulated area table 52b, the charging facility table 52c, the vehicle data file 52d, and the electricity supply data file 52e may simply be the data or may be a database. In addition, in the case where at least a part of one of the user table 52a, the underpopulated area table 52b, the charging facility table 52c, the vehicle data file 52d, and the electricity supply data file 52e is the database, the corresponding data file may be normalized, so as to further break the data groups.

Referring back to the description on FIG. 1, the control section 53 is configured to control operation of each of the sections of the vehicle information management device 50 such as the communication section 51 and the storage section 52. In addition, the control section 53 is configured to execute the programs stored in the storage section 52, so as to realize functions, which will be described later. For example, the control section 53 is configured to include a processor such as a central processing unit (CPU), memory such as read only memory (ROM) and random access memory (RAM), and buffer memory such as a buffer.

In addition, as a functional configuration thereof, the control section 53 includes the acquisition section 53a, a determination section 53b, a travel distance calculation section 53c, a travel duration calculation section 53d, an offering section 53e, an advertisement information provision section 53f, a charging facility information provision section 53g, for example.

The acquisition section 53a is configured to acquire the vehicle data including the location information and battery remaining amount information from the traveling vehicle V1. In addition, the acquisition section 53a is configured to acquire the electricity supply data from the vehicle V1.

For example, the acquisition section 53a receives and acquires the vehicle data and the electricity supply data, which are sent from the vehicle V1 via the network N1, by using the communication section 51. Then, the acquisition section 53a stores the acquired vehicle data in the corresponding vehicle data file 52d, and stores the acquired electricity supply data in the electricity supply data file 52e.

The determination section 53b is configured to determine whether the vehicle V1 has traveled in the specified underpopulated area on the basis of the location information included in the vehicle data. For example, the determination section 53b reads the vehicle data from the vehicle data file 52d. Then, in the case where current location information in the vehicle data is included in location information of one of the plural underpopulated areas, the information on which is stored in the underpopulated area table 52b, the determination section 53b determines that the vehicle V1, which is identified by the vehicle ID in the vehicle data, has traveled in the specified underpopulated area. On the other hand, in the case where the current location information in the read vehicle data is not included in the location information of all of the plural underpopulated areas, the information on which is stored in the underpopulated area table 52b, the determination section 53b determines that the vehicle V1, which is identified by the vehicle ID in the vehicle data, has not traveled in the specified underpopulated area.

The travel distance calculation section 53c is configured to calculate a travel distance, for which the vehicle V1 has traveled in the specified underpopulated area, on the basis of the location information included in the vehicle data. For example, the travel distance calculation section 53c reads plural types of the vehicle data from the vehicle data file 52d, and then calculates the travel distance, for which the vehicle V1 has traveled in the specified underpopulated area, on the basis of the current location information in each of the vehicle data and road information in the specified underpopulated area.

The travel duration calculation section 53d is configured to calculate travel duration, for which the vehicle V1 has traveled in the specified underpopulated area, on the basis of the location information included in the vehicle data. For example, the travel duration calculation section 53d reads the plural types of the vehicle data from the vehicle data file 52d, and compares the current location information included in each of the vehicle data with the location information of the traveled underpopulated area. Then, the travel duration calculation section 53d calculates the travel duration, for which the vehicle V1 has traveled in the specified underpopulated area, on the basis of the acquired date and time information in the vehicle data, in which the current location information is included in the location information.

The offering section 53e is configured to offer the travel reward to the user of the vehicle V1 in the case where it is determined that the vehicle V1 has traveled in the specified underpopulated area. In this way, the user of the vehicle V1 can be motivated to visit the underpopulated area. As a result, the vehicle and the user can be guided to the underpopulated area. Therefore, the underpopulated area can be revitalized.

In addition, the offering section 53e is configured to offer the supply reward to the owner of the charging facility, which has supplied the electricity, on the basis of the electricity supply information acquired from the vehicle V1. In this way, the owner of the charging facility can be a cooperator who cooperates in the revitalization of the underpopulated area where the charging facility is located. Thus, the number of the cooperators can be increased, and the underpopulated area can further be revitalized.

For example, each of the travel reward and the supply reward is a monetary gift such as money, electronic money, a check, a discount, a gift certificate, or a voucher. In this embodiment, each of the travel reward and the supply reward is points that can be used in the underpopulated area. Thus, when the user of the vehicle V1 uses the points or revisits the underpopulated area to use the points, the underpopulated area can further be revitalized.

Each of the travel reward and the supply reward can be offered by any of various means according to a type of the monetary gift. For example, in the case where the travel reward is the points that can be used in the underpopulated area, the offering section 53e creates a mail that contains a coupon image of the points offered as the travel reward, link information, a two-dimensional code such as a QR code®, and the like. Then, the offering section 53e reads an e-mail address of the user, to whom the travel reward is offered, from the user table 52a, and sends the created mail to the e-mail address. In the case where the supply reward is also the points that can be used in the underpopulated area, the offering section 53e reads owner account information of the owner of the charging facility from the charging facility table 52c, and updates the owner account information by adding the points offered as the supply reward to the owner account.

In the case where the travel reward is the check, the gift certificate, the voucher, or the like, the offering section 53e may read contact address information of the user, to whom the travel reward is offered, from the user table 52a, and may print the contact address on an envelope used to mail the travel reward. In the case where the supply reward is also the check, the gift certificate, the voucher, or the like, the offering section 53e may read the location information from the charging facility table 52c, and may print the location on an envelope used to mail the supply reward.

Each of the travel reward and the supply reward can be calculated by any of various methods. For example, the offering section 53e is configured to offer the travel reward, which is calculated according to the basis determined for each of the underpopulated areas, to the user of the vehicle V1. In this way, it is possible to calculate the travel reward according to the basis that differs by the underpopulated area. For example, the high travel reward can be offered in the underpopulated area with a large number of elders.

As one example, as illustrated in FIG. 3, in the case of the underpopulated area whose underpopulated area ID is “DA0001”, the offering section 53e uniformly offers “JJJ pt” (hereinafter the points may be referred to as “pt”) as the travel reward to the user of the vehicle V1 when it is determined that the vehicle V1 has traveled in the underpopulated area.

In another example, in the case of the underpopulated area whose underpopulated area ID is “DA0002”, the offering section 53e offers “K pt per km” as the travel reward to the user of the vehicle V1 when it is determined that the vehicle V1 has traveled in the underpopulated area. In this case, the offering section 53e calculates the travel reward by multiplying the travel distance in kilometers by unit points K. Just as described, by offering the travel reward according to the travel distance to the user of the vehicle V1, it is possible to increase a probability of the vehicle V1 to stay in the underpopulated area for long duration.

In yet another example, in the case of the underpopulated area whose underpopulated area ID is “DA0003”, the offering section 53e offers “L pt per hour” as the travel reward to the user of the vehicle V1 when it is determined that the vehicle V1 has traveled in the underpopulated area. In this case, the offering section 53e calculates the travel reward by multiplying the travel duration in hours by unit points L. Just as described, by offering the travel reward according to the travel duration to the user of the vehicle V1, it is possible to increase the probability of the vehicle V1 to stay in the underpopulated area for the long duration.

The advertisement information provision section 53f is configured to provide the advertisement information relating to the travel reward to the vehicle V1 on the basis of the location information included in the vehicle data. In this way, the user of the vehicle V1 can be notified of the reward to be offered in the underpopulated area, which is located near the traveling vehicle V1, and thus can be motivated to travel to the underpopulated area.

For example, the advertisement information provision section 53f reads the latest (last) vehicle data from the vehicle data file 52d, and calculates the distance on the basis of the current location information included in the vehicle data and the location information of each of the underpopulated area stored in the underpopulated area table 52b. In the case where each of the distances falls within a specified distance, that is, is equal to or shorter than a specified value, the advertisement information provision section 53f reads the advertisement information of the corresponding underpopulated area from the underpopulated area table 52b. Then, the advertisement information provision section 53f uses the communication section 51 to send the advertisement information to the vehicle V1 via the network N1.

The charging facility information provision section 53g is configured to provide the charging facility information relating to the charging facility located in the specified underpopulated area to the vehicle V1 on the basis of the location information and the battery remaining amount information included in the vehicle data. In this way, the user of the vehicle V1 can be notified of the charging facility that is located near the traveling vehicle V1, and thus can be motivated to travel to the underpopulated area where the charging facility is located.

For example, the charging facility information provision section 53g reads the latest (last) vehicle data from the vehicle data file 52d. In the case where the battery remaining amount in the battery remaining amount information included in the vehicle data is equal to or smaller than a specified value, the charging facility information provision section 53g compares the current location information and the location information included in the vehicle data in the charging facility table 52c to search for the nearest charging facility, and reads the charging facility information of such a charging facility. Then, the charging facility information provision section 53g uses the communication section 51 to send the charging facility information to the vehicle V1 via the network N1.

Each of the functions of the control section 53 can be realized by the programs executed by a computer (a microprocessor). Thus, each of the functions provided in the control section 53 can be realized by hardware, software, or a combination of the hardware and the software, and is not limited to any of the cases.

In addition, in the case where each of the functions of the control section 53 is realized by the software or the combination of the hardware and the software, processing thereof can be executed in the form of multitasking, multithreading, or both of the multitasking and the multithreading, and is not limited to any of the cases.

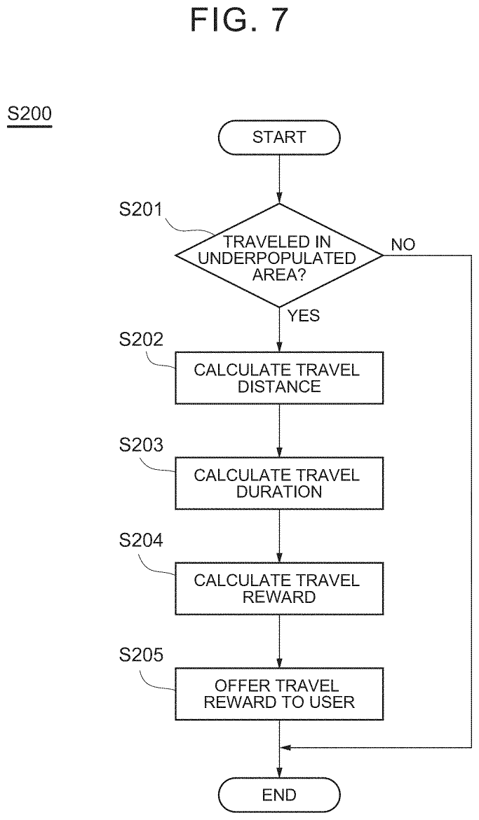

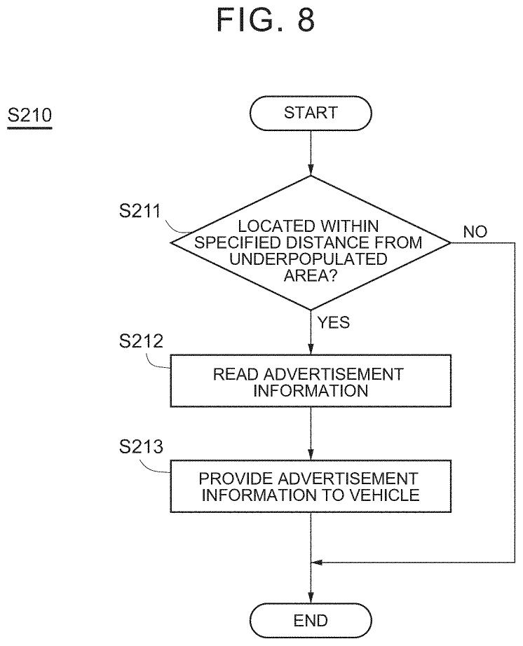

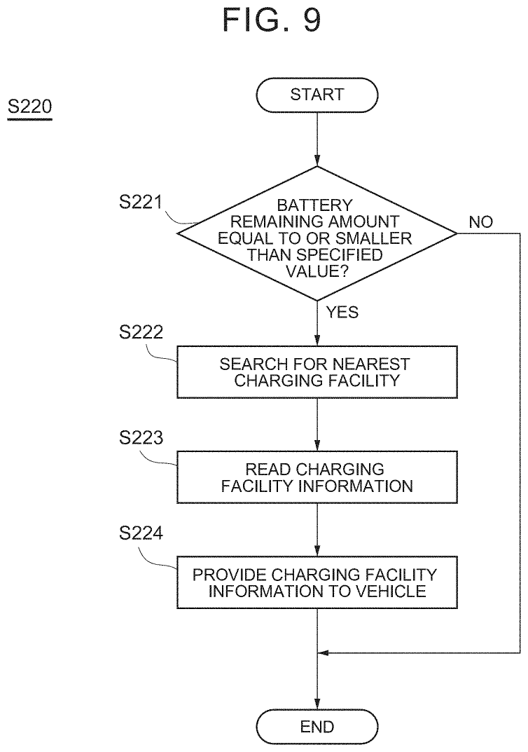

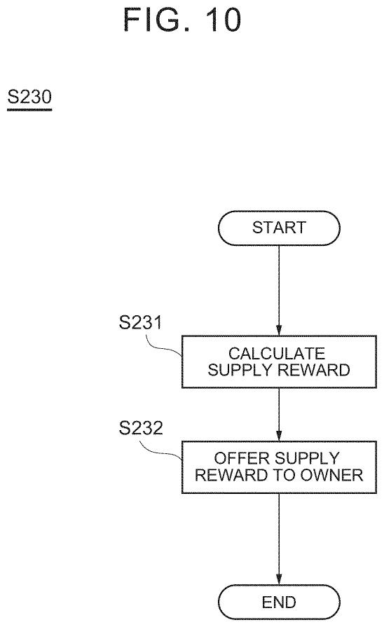

Next, a description will be made on operation of the vehicle information management device according to the embodiment with reference to FIG. 7 to FIG. 10. FIG. 7 is a flowchart illustrating schematic operation of the vehicle information management device 50 according to the embodiment that offers the travel reward. FIG. 8 is a flowchart illustrating schematic operation of the vehicle information management device 50 according to the embodiment that provides the advertisement information. FIG. 9 is a flowchart illustrating schematic operation of the vehicle information management device 50 according to the embodiment that provides the charging facility information. FIG. 10 is a flowchart illustrating schematic operation of the vehicle information management device 50 according to the embodiment that offers the supply reward.

<Travel Reward Offering Processing> For example, when the vehicle data is sent at least twice from the vehicle V1 and each of the vehicle data is stored in the corresponding vehicle data file 52d, the vehicle information management device 50 executes travel reward offering processing S200 shown in FIG. 7.

First, the determination section 53b determines whether the vehicle V1 has traveled in the specified underpopulated area (S201).

As a result of the determination in step S201, if the vehicle V1 has traveled in the specified underpopulated area, the travel distance calculation section 53c calculates the travel distance, for which the vehicle V1 has traveled in the underpopulated area, on the basis of the vehicle data stored in the vehicle data file 52d (S202).

Next, the travel duration calculation section 53d calculates the travel duration, for which the vehicle V1 has traveled in the underpopulated area, on the basis of the vehicle data stored in the vehicle data file 52d (S203).

Next, the offering section 53e reads the travel reward information of the underpopulated area, where the vehicle V1 has traveled, from the underpopulated area table 52b, and calculates the travel reward on the basis of the travel reward information (S204).

Next, the offering section 53e offers the travel reward calculated in step S204 to the user of the vehicle V1 (S205). After step S205, the control section 53 terminates the travel reward offering processing S200.

On the other hand, as the result of the determination in step S201, if the vehicle V1 does not travel in the specified underpopulated area, the control section 53 terminates the travel reward offering processing S200 without executing any processing.

<Advertisement Information Provision Processing> For example, when the vehicle data is sent from the vehicle V1 and the vehicle data is stored in the corresponding vehicle data file 52d, the vehicle information management device 50 executes advertisement information provision processing 5210 shown in FIG. 8.

First, the advertisement information provision section 53f determines whether the vehicle V1 is located within a specified distance from the specified underpopulated area on the basis of the current location information included in the vehicle data (S211).

As a result of the determination in step S211, if the vehicle V1 is located within the specified distance from the specified underpopulated area, the advertisement information provision section 53f reads the advertisement information of the underpopulated area from the underpopulated area table 52b (S212).

Next, the advertisement information provision section 53f uses the communication section 51 to send the advertisement information, which is read in step S212, to the vehicle V1 via the network N1, and provides the advertisement information to the vehicle V1 (S213). After step S213, the control section 53 terminates the advertisement information provision processing S210.

On the other hand, as the result of the determination in step S211, if the vehicle V1 is not located within the specified distance from the specified underpopulated area, the control section 53 terminates the advertisement information provision processing S210 without executing any processing.

<Charging Facility Information Provision Processing> For example, when the vehicle data is sent from the vehicle V1 and the vehicle data is stored in the corresponding vehicle data file 52d, the vehicle information management device 50 executes charging facility information provision processing S220 shown in FIG. 9.

First, the charging facility information provision section 53g determines whether the battery remaining amount indicated by the battery remaining amount information included in the vehicle data is equal to or smaller than the specified value (S221).

As a result of the determination in step S221, if the battery remaining amount is equal to or smaller than the specified value, the charging facility information provision section 53g searches for the nearest charging facility in the charging facility table 52c on the basis of the current location information included in the vehicle data (S222).

Next, the charging facility information provision section 53g reads the charging facility information of the nearest charging facility from the charging facility table 52c (S223). For example, the charging facility information read in step S223 includes the charging facility ID, the location information, and the like.

Next, the charging facility information provision section 53g uses the communication section 51 to send the charging facility information, which is read in step S223, to the vehicle V1 via the network N1, and provides the charging facility information to the vehicle V1 (S224). After step S224, the control section 53 terminates the charging facility information provision processing S220.

On the other hand, as the result of the determination in step S221, if the battery remaining amount is not equal to or smaller than the specified value, that is, if the battery remaining amount is larger than the specified value, the control section 53 terminates the charging facility information provision processing S220 without executing any processing.

<Supply Reward Offering Processing> For example, when the electricity supply data is sent from the vehicle V1 and the electricity supply data is stored in the electricity supply data file 52e, the vehicle information management device 50 executes supply reward offering processing S230 shown in FIG. 10.

First, the offering section 53e reads the supply reward information of the underpopulated area, where the charging facility that has supplied the electricity is located, from the underpopulated area table 52b, and calculates the supply reward on the basis of the supply reward information (S231).

Next, the offering section 53e offers the supply reward calculated in step S231 to the owner of the charging facility (S232). After step S232, the control section 53 terminates the supply reward offering processing S230.

The description has been made so far on the exemplary embodiment of the disclosure. According to the vehicle information management device 50 and the vehicle information management method according to this embodiment, in the case where it is determined that the vehicle V1 has traveled in the specified underpopulated area, the travel reward is offered to the user of the vehicle V1. In this way, the user of the vehicle V1 can be motivated to visit the underpopulated area. As a result, the vehicle and the user can be guided to the underpopulated area. Therefore, the underpopulated area can be revitalized.

The embodiment that has been described so far is merely provided to facilitate understanding of the disclosure, and thus is not provided to limit interpretation of the disclosure. Each of the elements included in the embodiment as well as arrangement, a material, a condition, a shape, size, and the like thereof is not limited to what has been exemplified above and can appropriately be changed. In addition, the components described in the different embodiments can partially be replaced or combined.

What is claimed is:

1. A vehicle information management device comprising:
an acquisition section that acquires location information from a traveling vehicle;
a determination section that determines whether the vehicle has traveled in a specified underpopulated area based on the location information; and
an offering section that offers a travel reward to a user of the vehicle in a case where it is determined that the vehicle has traveled in the specified underpopulated area.

2. The vehicle information management device according to claim 1 further comprising:
a travel distance calculation section that calculates a travel distance, for which the vehicle has traveled in the specified underpopulated area, based on the location information, wherein
the offering section offers the travel reward according to the travel distance to the user of the vehicle.

3. The vehicle information management device according to claim 1 further comprising:
a travel duration calculation section that calculates travel duration, for which the vehicle has traveled in the specified underpopulated area, based on the location information, wherein
the offering section offers the travel reward according to the travel duration to the user of the vehicle.

4. The vehicle information management device according to claim 1 further comprising:
an advertisement information provision section that provides advertisement information relating to the travel reward to the vehicle based on the location information.

5. The vehicle information management device according to claim 1, wherein
the vehicle information management device further includes a charging facility information provision section that acquires battery remaining amount information indicative of a battery remaining amount from the vehicle when the vehicle is an electrically-driven vehicle, and provides charging facility information relating to a charging facility located in the specified underpopulated area to the vehicle based on the location information and the battery remaining amount information.

6. The vehicle information management device according to claim 1, wherein
the acquisition section acquires, from the vehicle, electricity supply information indicating that the electricity has been supplied from a charging facility located in the specified underpopulated area, and
the offering section offers a supply reward to an owner of the charging facility based on the electricity supply information.

7. The vehicle information management device according to claim 1, wherein
the travel reward includes points that can be used in the specified underpopulated area.

8. The vehicle information management device according to claim 1, wherein
the specified underpopulated area includes plural underpopulated areas, and
the offering section offers the travel reward, which is calculated according to a basis determined for each of the underpopulated areas, to the user of the vehicle.

9. A vehicle information management method comprising:
a step of acquiring location information from a traveling vehicle;
a step of determining whether the vehicle has traveled in a specified underpopulated area based on the location information; and
a step of offering a travel reward to a user of the vehicle in a case where it is determined that the vehicle has traveled in the specified underpopulated area.
